(19) United States
(12) Patent Application Publication
(10) Pub. No.: US 2021/0225044 A1
(43) Pub. Date: Jul. 22, 2021

(54) System and Method for Object Arrangement in a Scene

(71) Applicant: Trisetra, Inc., Palo Alto, CA (US)

(72) Inventor: Ajay Kumar Mishra, Palo Alto, CA (US)

(21) Appl. No.: 17/152,683

(22) Filed: Jan. 19, 2021

Related U.S. Application Data
(60) Provisional application No. 62/962,169, filed on Jan. 16, 2020.

(51) Int. Cl. G06T 11/00; G06T 17/00; G06T 7/60; G06K 9/00; G06T 3/20; G06T 3/60

(52) U.S. Cl. CPC G06T 11/00; G06T 17/00; G06T 7/60; G06T 2200/24; G06T 3/20; G06T 3/60; G06K 9/00624

(57) ABSTRACT

Methods and systems for arranging objects in a scene allowing movement of objects in a manner compatible with characteristics of the objects and scene, using semantic information of the objects and the scene.

### TECHNICAL FIELD

The present disclosure relates generally to mixed reality, augmented reality (AR), and virtual reality (VR) systems that arrange and display objects in a scene. In particular, some embodiments relate to placement and movement of objects in a manner compatible with characteristics of the objects and scene, using semantic information of the objects and the scene.

### BACKGROUND

Current mixed reality and augmented reality (AR) systems use a continuous stream of images to localize themselves as well build an approximate map of the surrounding simultaneously (aka SLAM systems). While this helps visualize an augmented object from new viewpoints, the computational cost of tracking the object and lack of detailed scene description prevents users from engaging in rich and valuable interactions with the scene. Such systems also require users to be physically present at the scene to interact with it. Additionally, these systems have to relocalize themselves significantly accurately to make user interactions persist between multiple sessions across time. In addition, there are 2D methods to overlay photos of objects onto the photos of the room. These techniques of incorporating images may not adequately ensure proper placement or display of the images and may not account for characteristics of the objects or scene. For example, current techniques of rendering virtual furniture in a photo of a room may display an image of a table or chair suspended in the air, rather than resting on the floor, or display an image of a clock in front of a chandelier when the clock should be occluded because it is behind the chandelier. These shortfalls are addressed by the present invention.

### SUMMARY

Various embodiments of the present invention provide a system and method for incorporating one or more objects or entities in a scene. A scene may include without limitation a room, hallway, convention hall, other interior space of a building, courtyard, backyard, other outdoor space, or any portion or combination of the above. Objects may include without limitation chairs, couches, ottomans, tables, shelves, nightstands, beds, other furniture, clocks, computers, TVs, other electronics, stoves, microwaves, refrigerators, other appliances, faucets, fans, paintings, pictures, sculptures, fountains, lamps, chandeliers, lights, shutters, rugs, blinds, curtains, other furnishings, plants, or other movable things. Entities may include without limitation people, animals, or other moving things. In some embodiments, the system and method may select from a repository or database of objects, entities, or scenes, including three-dimensional (3D) objects, entities, or scenes. In some embodiments, the system and method may display objects or entities in a two-dimensional (2D) image or video of a scene. In some embodiments, a user may input one or more 2D images or videos of a scene, and the system and method may display the scene in 3D, such as in a head-mounted device or holographic display.

The models, including 3D models, of objects, entities, or scenes may be generated by the system, downloaded from a repository or database, previously built by a user or by another user, for example using a photogrammetry software, or any combination of the above. The models may be saved in any format, including GLTF, FBX, and OBJ formats. Models may comprise geometric and semantic information. Geometric information may include 3D coordinates, length, width, height, scale, rotation, translation, other transformations, curvature, surface normal, geometric primitives such as planes or cuboids, or other parameters. Semantic information may include object name, other labels, affordances such as the object's function, ontology information such as object type, maintenance information, warranty information, purchase information such as a date or price, notes, or other information about the object, entity, or scene. Semantic information may include information relating to another object or entity, such as a family or hierarchy relationship, relative position, or a minimum threshold or maximum distance between the object or entity and another object or entity, or compatibility between the object or entity and another object or entity.

In some embodiments, a 3D model of an object, entity, or scene may be generated from one or more 2D images or videos; user input relating to an element in the scene such as a height of a ceiling or a height of a door; camera parameters; other information or metadata relating to the scene, image, or video; or any combination of the above. In some embodiments, the camera parameters may be inferred from one or more sensors such as an image or depth sensor, compass, or accelerometer; location information such as information from cellular, Bluetooth, WiFi, or GPS; the user's height or position, which may be input by the user; the images or videos recorded by the camera, such as the perspective of objects in the image or video; or any combination of the above.

The system and method may involve scene understanding. In some examples, the scene understanding may include creating a segmentation mask. In an example of a room of a house, the segmentation mask may comprise a ceiling, floor, walls, objects, doors, windows, and furniture. In response to creating a segmentation mask, the system may distinguish fixed elements in the scene from dynamic elements. Examples of fixed elements may include a door, floor, ceiling, wall, opening, or window. Examples of dynamic elements include movable objects such as a lamp, table, couch or chair.

The system may detect certain lines and shapes in the photo and determine their respective locations, which may be inferred from the location of the camera used to take the photo. Non-limiting examples of such lines and shapes include ceiling lines, wall corners, window openings, floor lines and other commonly seen architectural elements. The detection may be an automatic process. The system may further infer or calculate camera geometry using or based on elements in the scene. Camera geometry may include camera extrinsic parameters such as camera position, translation, rotation, and other transformations from 3D world coordinates to 3D camera coordinates; and camera intrinsic parameters such as a focal length, image sensor size and shape, or other physical property of the camera. The system may further infer a geometry of the scene, for example, including relationships between elements in the scene. The system may then determine a location of a window, door, or other element in the scene, and determine an initial position of an object or entity relative to the window, door, or other element in the scene.

The detection may be made by the system from one or more acquired 2D images or videos without requiring the presence of any specific hardware or scanning technology. The system may measure the lengths of lines in the scene. In some embodiments, lengths may be estimated from proportions or relationships to other known or estimated lengths. With the detected lines and shapes and optionally with the inferred camera location, the system can then localize each object in the image.

In certain examples, when more than one images are used, a correspondence relationship can be established between the images based on common scene elements or objects appearing in the different images. The use of multiple images can further verify the identification of the objects, as well as the locations of the objects. Accordingly, a multiple-view reconstruction of the objects and the scene can be carried out.

Detection may involve convolutional neural networks (CNN). A convolutional neural network is a self-learning neural network of multiple layers that are progressively trained to initially recognize edges, lines, and densities of abstract features, and to identify object parts formed by the abstract features from the edges, lines, and densities. As the self-learning and training progresses through the many neural layers, the convolutional neural network can begin to detect objects and scenes.

In convolutional neural network training, classifier layers (or simply neural layers) may be trained on different data types to classify low-level, mid-level, and high-level features. The low-level layers may initially recognize edges, lines, colors, and/or densities of abstract features. The mid-level layers may detect mid-level cues, such as surface normal, curvature, and segmentation. The high-level layers may identify objects, entities, or elements in a scene. As the self-learning and training of the convolutional neural network progresses through the classifier layers, the fully-connected layers of the convolutional neural network can detect objects and scenes, such as for object detection and image classification. In some embodiments, the system may combine low-level, mid-level, and/or high-level cues.

In some embodiments, image segmentation is carried out for each image which partitions the image into regions (segments) to identify groups of pixels in the image that are associated with one or more objects, entities, or elements in a scene. In some embodiments, the image segmentation engine does not consider the spatial relationships between pixels in the image during the segmentation. Instead, pixels are classified according to groupings they form when their individual properties are plotted in a feature space which does not take account of spatial relationships. The feature space may be characterized by parameters considered appropriate for differentiating between pixels associated with the object(s) of interest and other pixels. These approaches include techniques such as thresholding, color depth reduction, histogram splitting and feature-space clustering. In another embodiment, the segmentation engine takes as input spatial information. These may be based on techniques such as “region growing,” “split and merge,” “watershed,” or “edge detection and linking.” These schemes consider both the relative positions of pixels and the similarities/differences among them.

The system and method may determine an initial placement of an object or entity into the scene. In some embodiments, the determining of the initial placement may be in response to a user action such as a user selecting one or more objects or entities using natural language text or audio search, clicking on descriptions of objects in a list, or selecting objects from a visual catalog. In some embodiments, the system and method may automatically populate or place one or more objects or entities into the scene. In some embodiments, determining the initial placement may comprise comparing a model of an object or entity to a model of the scene.

The determining of the initial placement may be based on historical data and/or user preferences. The system may comprise a recommendation engine. Machine learning techniques may be used to learn user preferences based on where the user or other users have placed objects or entities historically in the scene or similar scenes. For example, the system may comprise a machine-learning recommendation engine that takes type, color, texture, position, and/or orientation of objects, entities, or elements in the scene as inputs to generate color, texture, position, and or orientation of a selected object or entity. The system may optimize certain parameters based on user preference, input, or other criteria. For example, given a selection of objects or entities and the scene, the system may maximize light, natural light, or the area of unoccupied floor space or other surfaces. In some embodiments, a user may provide input on user preference or criteria, for example, “I want to keep the middle of the room open.” The system may apply such preference or criteria as a constraint.

Determining the initial placement may use geometric and semantic information of the object, entity, or scene. For example, the semantic information may comprise information that a lamp may be plugged into a wall outlet in the scene. Thus, the system may initially place the lamp near the wall outlet, based on a cord length of the lamp. As another example, the semantic information may comprise information that a lamp should be placed a certain distance from another light fixture to provide uniform lighting in the room. Thus, the system may place the lamp a certain distance from a chandelier in the scene. In other examples, the system may place a chandelier on a ceiling, blinds on a window, or a flower pot on a window sill.

In some embodiments, 2D input of a user may result in 3D movements of objects or entities. This allows a user to interact with a 2D display of an object and scene as if in 3D. For example, a user may select an object such as a clock and tap on a position on a wall in a 2D image, and the system can move the clock to that position on the wall, such that the back of the clock is aligned with the surface of the wall and the face of the clock is away from the wall. A 2D user input may be a 2-D mouse interaction, such as a user moving or dragging a mouse cursor, or a gesture on a 2D touch screen, such as tapping or sliding across a flat screen. In some embodiments, the system may receive 3D user input, such as hand movements detected by cameras, data gloves, or other sensors. In response to 3D input moving an object or entity, the system may display the movement in a 2D image or video or a 3D display.

The system and method may control the object's or entity's movement, both translational or rotational, or an interaction of the object or entity in the scene with another object or entity, or another structure. The control of the movement may be restricted based on geometric and semantic information of the object or entity and the scene. In some examples, the constraints may comprise restrictions of degrees of freedom of the object or entity, specific planes that the object or entity are confined to be translated or moved in, and/or specific axes that a center of, a portion of, or an entirety of the object or entity, are confined to rotate about. F In some examples, the semantic information may comprise information of different configurations of an object or entity, such as blinds rolled up or rolled down. In such a manner, controlling an interaction of the object or entity may include displaying or modeling the blinds in different configurations, such as entirely rolled down, partially rolled up, or completely rolled up.

In some embodiments, the techniques previously described for initial placement may also be used to control or restrict a movement or an interaction of the object or entity in the scene. For example, the movement or the interaction of the object or entity may be controlled or restricted using, or based on, information of, a curvature or a surface normal of the object or entity, and of one or more surfaces of the scene. The one or more surfaces of the scene may be defined in terms of orthogonal planes. For example, an object or entity may be confined to be translated along a particular surface of the scene, such as a ground, or along a wall. Thus, the system may constrain the object or entity such that its surface normal is aligned with and coincides with a surface normal of a particular surface.

In some embodiments, an object or entity may be manipulated in the scene by extracting and removing the object or entity, including objects or entities that appear in the scene in the 2D image or video input. In some embodiments, one or more existing fixed scene elements, such as a crown in the ceiling, may be extracted or removed. In some embodiments, colors of elements such as a wall, or other elements in the scene may be changed. The user may switch objects or entities appearing in the scene in the 2D image or video input with other objects or entities. For example, in response to a user selecting a bed in a scene and selecting a different bed from a catalog, the system may replace the bed in the image or video input with the different bed.

In some embodiments, the system may save geometric information and semantic information as state information of objects or entities in the scene, and restore the state information when the user accesses the scene. As a result, changes that the user or system has made to the scene in a previous session, including addition or movement of objects, will persist in the next session. State information may include identification, location, rotation, scaling, and color attributes of an object. Semantic information may be stored in a string array as part of exif data associated with an image or video.

In some embodiments, an object or entity may be annotated with a note by the user. The annotation may be in 3D and stored as part of the semantic information for the object or entity. The note may be displayed to a user in response to a user clicking on or touching the object or entity.

### BRIEF DESCRIPTION OF THE DRAWINGS

Certain features of various embodiments of the present technology are set forth with particularity. A better understanding of the features and advantages of the technology will be obtained by reference to the following detailed description that sets forth illustrative embodiments, in which the principles of the invention are utilized, and the accompanying drawings of which:

FIG. 1 illustrates an example implementation of a system that performs an initial placement of one or more objects or entities into a scene. In FIG. 1, a user may select one or more objects or entities from a selection menu 102. Upon selection, the one or more objects or entities may be auto populated into a scene, which may comprise a ground 106, a wall 108, a window wall 109, a window 110, and a ceiling 112. Because the user selected a lamp, the system may autopopulate a lamp 104 into the scene, using geometric and semantic information of the lamp 104 and the scene. In some embodiments, the system may position a base of the lamp 104 to contact the ground 106. In some examples, the system may position the lamp 104 so that it does not obscure the window 110, to provide an improved aesthetic effect, and to provide uniform lighting because an area near the window 110 may be brighter during daytime. In some examples, the system may position the lamp 104 so that a distance between the lamp 104 and a wall outlet is less than or equal to a cord length of the lamp 104. In some examples, the system may position the lamp 104 so that it is a certain distance away from the wall 108 or the window wall 109, or a door so that the door does not hit the lamp 104 when the door is opened. In some examples, the system may not populate the lamp 104 into the scene if the system determines that the lamp 104 has a height exceeding that of the ceiling 112. Once the system performs the initial placement, the user may use a cursor 105 to move the lamp 104.

FIG. 2 illustrates an example implementation of a system that controls or restricts a movement or interaction of one or more objects or entities in a scene. In FIG. 2, a user may have already selected one or more objects or entities from a selection menu 202, and a lamp 204 may have been auto populated into a scene, which may comprise a ground 206, a wall 208, a window wall 209, a window 210, and a ceiling 212. The user may control the movement of the lamp 204 using a cursor 205. The system may restrict the movement of the lamp 204 using geometric and semantic information of the lamp 204 and the scene. In some embodiments, the system may restrict a movement of the lamp 204 such that the lamp 204, specifically, a base or bottom of the lamp 204, is contacting the ground 206. In some embodiments, the system may restrict the lamp 204 from obscuring the window 210, to provide an improved aesthetic effect, and to provide uniform lighting because an area near the window 210 may be brighter during daytime. In some examples, the system may restrict a position of the lamp 204 so that a distance between the lamp 204 and a wall outlet is less than or equal to a cord length of the lamp 204. In some examples, the system may restrict the lamp 204 from being a certain proximity to the wall 208 or the window wall 209, or a door so that the door does not hit the lamp 204 when the door is opened. In some examples, the system may restrict a rotation of the lamp 204 to a rotation about a vertical axis, in a direction from the ground 206 to the ceiling 212.

FIG. 3 illustrates an example implementation of a system that performs an initial placement of one or more objects or entities into a scene and controls or restricts a movement or interaction of one or more objects or entities in a scene. In FIG. 3, a user may select one or more objects or entities from a selection menu 302. Upon selection, the one or more objects or entities may be auto populated into a scene, which may comprise a ground 306, a wall 308, a window wall 309, a window 310, and a ceiling 312. A lamp 304 may have been previously selected by the user and saved in the scene. When the user accesses the scene, the lamp 304 is automatically placed in the scene where the user had last moved the lamp to. Because the user additionally selected a wall clock, the system may auto populate a wall clock 314 into the scene, using geometric and semantic information of the wall clock 314, the lamp 304, and the scene. In some embodiments, the system may position the wall clock 314 such that a back of the wall clock 314 contacts the wall 309. In some examples, the system may position the wall clock 314 based on the height of the user, so that the user can easily view the wall clock 314. For example, the wall clock 314 may be positioned 1 foot or 2 feet above the height of the user. In some examples, the system may position the wall clock 314 so that it would not be obscured by an opening and closing of a door. In some examples, the system may rearrange or reconfigure other objects or entities, such as the lamp 304, based on a position of the wall clock 314.

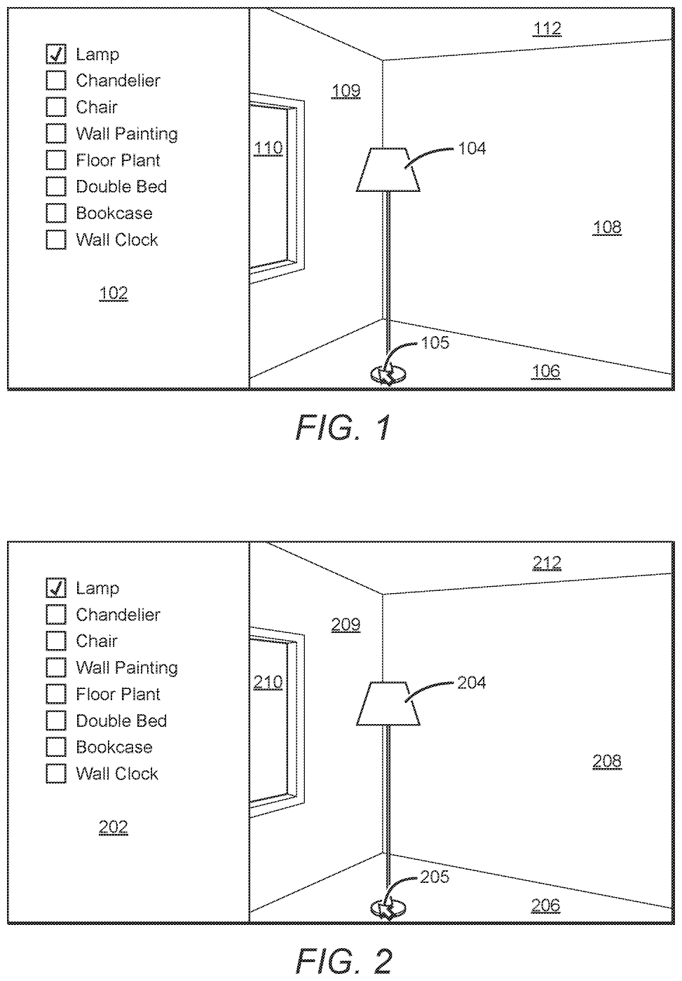

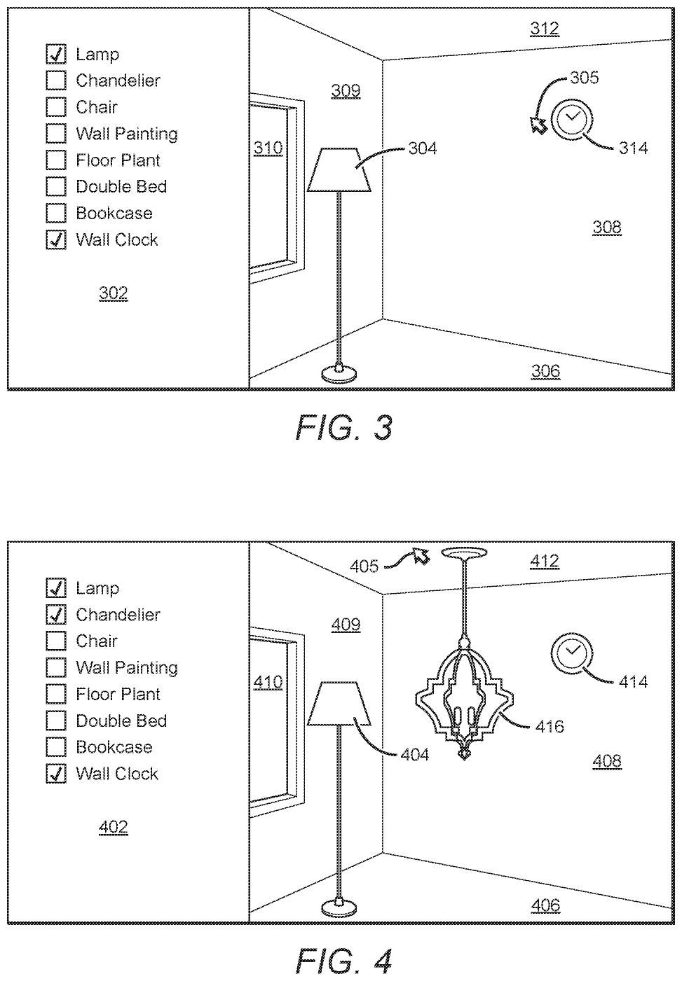

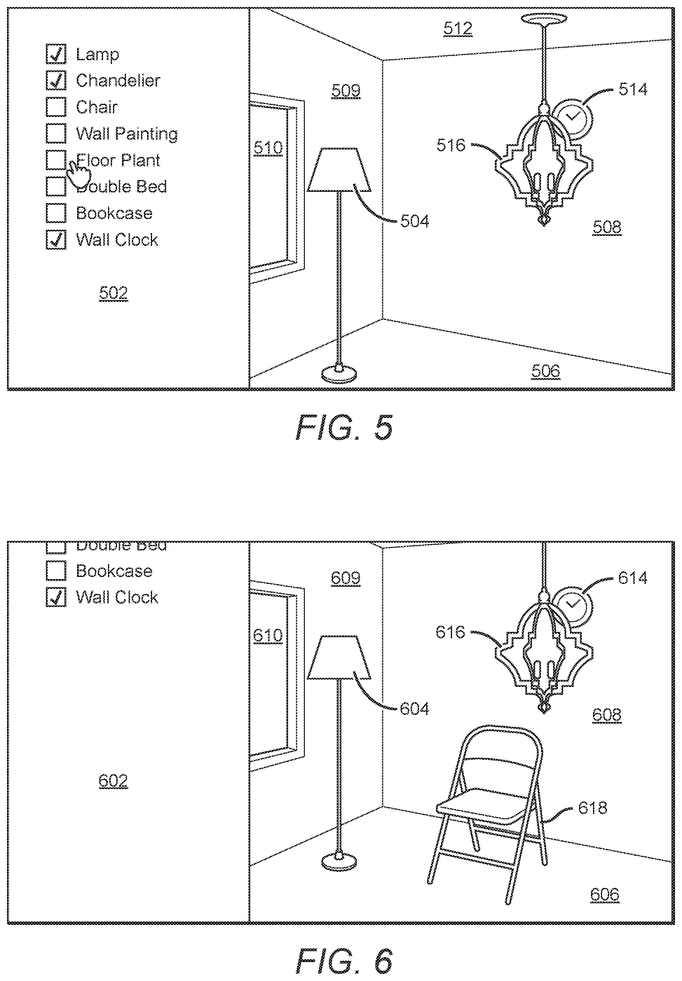

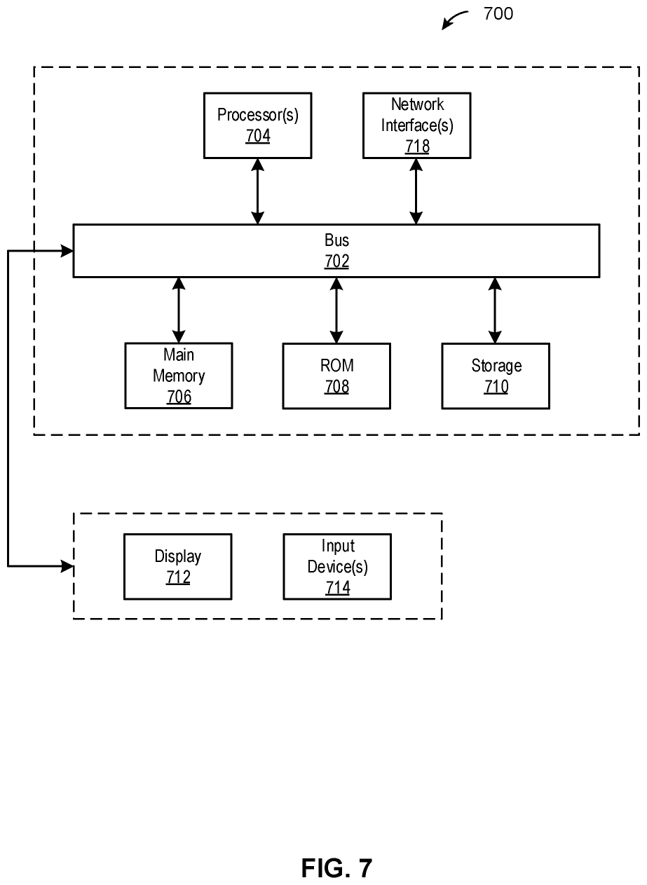

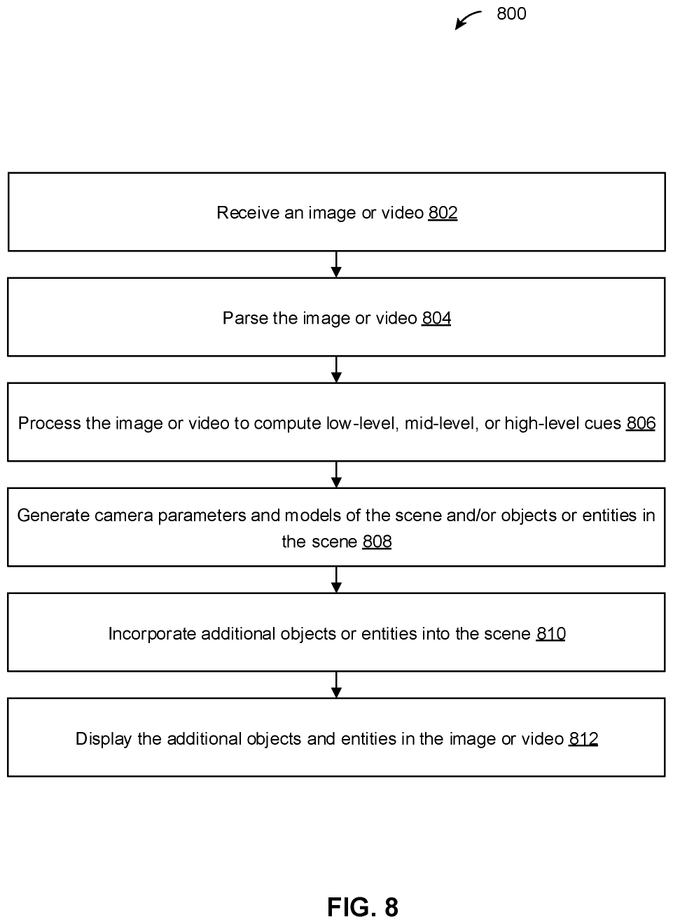

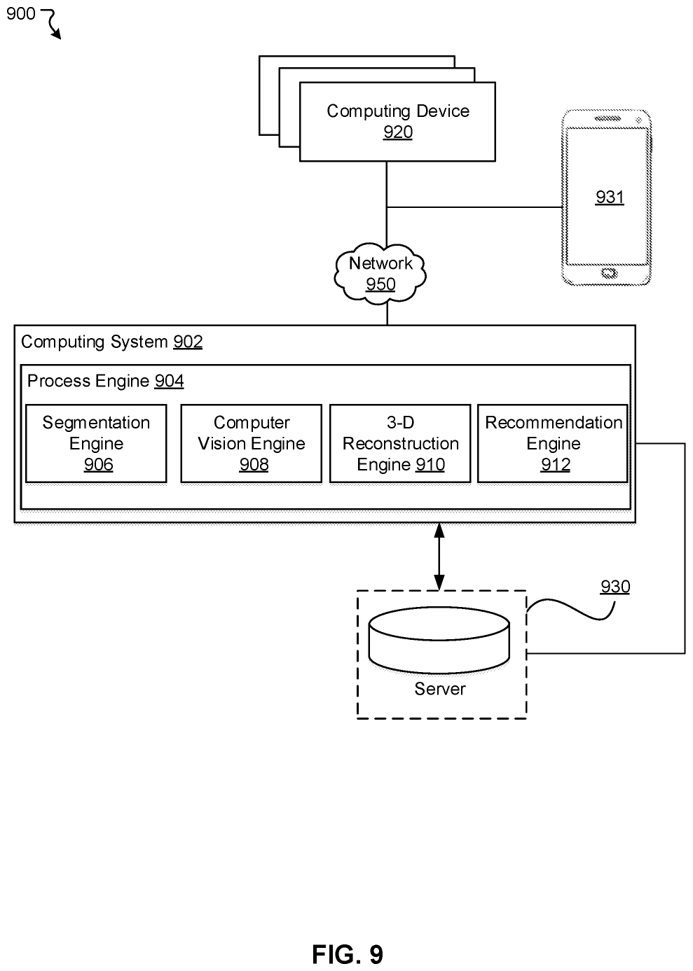

The user may then use a cursor 305 to move the wall clock 314. In some embodiments, the system may restrict movement of the wall clock 314 to the wall 309. In some examples, the system may not allow the wall clock 314 to be moved to a position that would be obscured by an opening and closing of a door. In some examples, the system may not allow the wall clock 314 to be moved to a position below a certain height, which may be based on the height of the user. In some examples, the user may click on a position on the wall 308, and the system will move the wall clock 314 to the position on wall 308 clicked by the user and reorient the wall clock 314 such that the back of the clock is in contact with wall 308 and the face of wall clock 314 is away from wall 308. In some examples, the system may reconfigure or rearrange a location of the lamp 304 based on movement of the wall clock 314. For example, the system may reconfigure or rearrange a location of the lamp 304 based on aesthetic or feng shui effects.

FIG. 4 illustrates an example implementation of a system that performs an initial placement of one or more objects or entities into a scene and controls or restricts a movement or interaction of one or more objects or entities in a scene. In FIG. 4, a user may select one or more objects or entities from a selection menu 402. Upon selection, the one or more objects or entities may be autopopulated into a scene, which may comprise a ground 406, a wall 408, a window wall 409, a window 410, and a ceiling 412. A lamp 404 and a wall clock 414 may have been previously selected by the user and saved in the scene. Because the user additionally selected a chandelier, the system may autopopulate a chandelier 416 into the scene, using geometric and semantic information of the wall clock 414, the lamp 404, the chandelier 416, and the scene. In some embodiments, the system may position the chandelier 416 such that a top of the chandelier 416 contacts the ceiling 412. In some examples, the system may position the chandelier 416 at or within a certain distance of a center of the ceiling 412. In some examples, the system may position the chandelier 416 so that it does not collide with other objects or entities such as the lamp 404 and wall clock 414. In some examples, the system may position the chandelier 416 so that it is a certain distance away from the lamp 404, because the chandelier 416 and the lamp 404 may be objects of the same type or category, and/or serve a common function. In some embodiments, the system may not auto populate the chandelier 416 if it may be dangerous. For example, the chandelier 416 may extend too close to the ground 406. In some examples, the system may rearrange or reconfigure other objects or entities, such as the lamp 404 and/or the wall clock 414, based on a position of the chandelier 416.

The user may then use a cursor 405 to move the chandelier 416. In some embodiments, the system may restrict movement of the chandelier 416 to the ceiling 412. In some examples, the system may restrict a movement of the chandelier 416 so that the chandelier 416 moves within a certain distance of a center of the ceiling 412. In some examples, the system may restrict movement of the chandelier 416 so that it does not collide with other objects or entities such as the lamp 404 and the wall clock 414. In some examples, the system may restrict movement of the chandelier 416 so that it is a certain distance away from the lamp 404, because the chandelier 416 and the lamp 404 may be objects of the same type or category, and/or serve a common function.

FIG. 5 illustrates an example implementation of a system that detects and renders occlusion of objects or entities in a scene. FIG. 5 illustrates a movement of a chandelier 516 relative to the location of the chandelier 416 in FIG. 4. In FIG. 5, a scene may comprise a ground 506, a wall 508, a window wall 509, a window 510, and a ceiling 512. A lamp 504 and a wall clock 514 may have been previously selected from menu 502 and saved in the scene. Because the user additionally selected a chandelier, the system may auto populate a chandelier 516 into the scene in the same relative location as chandelier 416 in the scene shown in FIG. 4. As the user moves the chandelier 516 in front of the wall clock 514 from the perspective of the user, the system recognizes that the chandelier 516 is in front of the wall clock 514 based on geometric and semantic information of the chandelier 416, wall clock 414, and scene, including 3D coordinates of the chandelier 516, wall clock 514, and camera position, and the system renders the image of the wall clock 516 partially occluded by the chandelier 416. The system also renders the image of the chandelier 516 larger in scale relative to the image of the chandelier 416 in FIG. 4 based on the system's recognition of the closer proximity of chandelier 516 to the camera. In some examples, as the chandelier 516 is moved in front of other objects like lamp 504 from the perspective of the user, the system renders those portions of the objects behind the chandelier 516 as occluded.

FIG. 6 illustrates an example implementation of a system that performs an initial placement of one or more objects or entities into a scene and controls or restricts a movement or interaction of one or more objects or entities in a scene. In FIG. 6, a user may select one or more objects or entities from a selection menu 602. Upon selection, the one or more objects or entities may be auto populated into a scene, which may comprise a ground 606, a wall 608, a window wall 609, a window 610, and a ceiling 612. A lamp 604, a wall clock 614, and a chandelier 616 may have been previously selected by the user and saved in the scene. Because the user additionally selected a chair 618, the system may auto-populate the chair 618 into the scene, using geometric and semantic information of the wall clock 614, the lamp 604, the chandelier 616, the chair 618, and the scene. In some embodiments, the system may position the chair 618 and control or restrict a movement of the chair 618 such that the chair 618, specifically, a bottom of the chair 618, contacts the ground 606. The system may restrict movement of the chair 618 such that the back of the chair 618 does not extend past wall 608. In some examples, the system may rearrange or reconfigure other objects or entities, such as the lamp 604, the chandelier 616, and/or the wall clock 614, based on a position or movement of the chair 618.

Hardware Implementation

The techniques described herein may be implemented by one or more special-purpose computing devices. The special-purpose computing devices may be hard-wired to perform the techniques, or may include circuitry or digital electronic devices such as one or more application-specific integrated circuits (ASICs) or field programmable gate arrays (FPGAs) that are persistently programmed to perform the techniques, or may include one or more hardware processors programmed to perform the techniques pursuant to program instructions in firmware, memory, other storage, or a combination. Such special-purpose computing devices may also combine custom hard-wired logic, ASICs, or FPGAs with custom programming to accomplish the techniques. The special-purpose computing devices may be desktop computer systems, server computer systems, portable computer systems, handheld devices, smartphones, head-mounted devices, networking devices or any other device or combination of devices that incorporate hard-wired and/or program logic to implement the techniques.

Computing device(s) may be controlled and coordinated by operating system software, such as macOS, Android, Chrome OS, Windows 10, Windows XP, Windows Vista, Windows 7, Windows 8, Windows Server, Windows CE, Unix, Linux, SunOS, Solaris, iOS, Blackberry OS, VxWorks, or other compatible operating systems. In other embodiments, the computing device may be controlled by a proprietary operating system. Operating systems may control and schedule computer processes for execution, perform memory management, provide file system, networking, I/O services, and provide a user interface functionality, such as a graphical user interface (“GUI”), among other things.

FIG. 7 is a block diagram that illustrates a computer system 700 upon which any of the embodiments described herein may be implemented. The computer system 700 may include a bus 702 or other communication mechanism for communicating information, and one or more hardware processors 704 coupled with bus 702 for processing information. Hardware processor(s) 704 may be, for example, one or more general purpose microprocessors, CPU, or GPU.

The computer system 700 may include a main memory 706, such as a random access memory (RAM), cache and/or other dynamic storage devices, coupled to bus 702 for storing information and instructions to be executed by processor 704. Main memory 706 also may be used for storing temporary variables or other intermediate information during execution of instructions to be executed by processor 704. Such instructions, when stored in storage media accessible to processor 704, render computer system 700 into a special-purpose machine that is customized to perform the operations specified in the instructions.

The computer system 700 may further include a read only memory (ROM) 708 or other static storage device coupled to bus 702 for storing static information and instructions for processor 704. A storage device 710, such as a solid state drive, magnetic disk, optical disk, or USB thumb drive (Flash drive), etc., may be coupled to bus 702 for storing information and instructions.

The computer system 700 may be coupled via bus 702 to display 712, such as a cathode ray tube (CRT), LCD display, touch screen, or holographic display, for displaying information to a user. Input device(s) 714, such as a keyboard, mouse, trackpad, touch screen, dataglove, or cyber glove, may be coupled to bus 702 for communicating information and command selections to processor 704 and for controlling movement of images on display 712. In some embodiments, display 712 and input device 714 may be the same physical component, such as a touch screen.

The computing system 700 may include a user interface module to implement a GUI that may be stored as executable software code. This and other modules may include, by way of example, components, such as software components, object-oriented software components, class components and task components, processes, functions, attributes, procedures, subroutines, segments of program code, drivers, firmware, microcode, circuitry, data, databases, data structures, tables, arrays, and variables.

In general, the word “module,” as used herein, refers to logic embodied in hardware or firmware, or to a collection of software instructions, possibly having entry and exit points, written in a programming language, such as, for example, Java, C or C++. A software module may be compiled and linked into an executable program, installed in a dynamic link library, or may be written in an interpreted programming language such as, for example, BASIC, Perl, or Python. It will be appreciated that software modules may be callable from other modules or from themselves, and/or may be invoked in response to detected events or interrupts. Software modules configured for execution on computing devices may be provided on a computer readable medium, such as a compact disc, digital video disc, flash drive, magnetic disc, or any other tangible medium, or as a digital download (and may be originally stored in a compressed or installable format that requires installation, decompression or decryption prior to execution). Such software code may be stored, partially or fully, on a memory device of the executing computing device, for execution by the computing device. Software instructions may be embedded in firmware, such as an EPROM. It will be further appreciated that hardware modules may be comprised of connected logic units, such as gates and flip-flops, and/or may be comprised of programmable units, such as programmable gate arrays or processors. The modules or computing device functionality described herein are preferably implemented as software modules, but may be represented in hardware or firmware. Generally, the modules described herein refer to logical modules that may be combined with other modules or divided into sub-modules despite their physical organization or storage.

The computer system 700 may implement the techniques described herein using customized hard-wired logic, one or more ASICs or FPGAs, firmware and/or program logic which in combination with the computer system causes or programs computer system 700 to be a special-purpose machine. According to one embodiment, the techniques herein are performed by computer system 700 in response to processor(s) 704 executing one or more sequences of one or more instructions contained in main memory 706. Such instructions may be read into main memory 706 from another storage medium, such as storage device 710. Execution of the sequences of instructions contained in main memory 706 causes processor(s) 704 to perform the process steps described herein. In alternative embodiments, hard-wired circuitry may be used in place of or in combination with software instructions.

The term “non-transitory media,” and similar terms, as used herein refers to any media that store data and/or instructions that cause a machine to operate in a specific fashion. Such non-transitory media may comprise non-volatile media and/or volatile media. Nonvolatile media includes, for example, optical or magnetic disks, such as storage device 710. Volatile media includes dynamic memory, such as main memory 706. Common forms of nontransitory media include, for example, a floppy disk, a flexible disk, hard disk, solid state drive, magnetic tape, or any other magnetic data storage medium, a CD-ROM, any other optical data storage medium, any physical medium with patterns of holes, a RAM, a PROM, and EPROM, a FLASH-EPROM, NVRAM, any other memory chip or cartridge, and networked versions of the same.

Non-transitory media is distinct from but may be used in conjunction with transmission media. Transmission media participates in transferring information between nontransitory media. For example, transmission media includes coaxial cables, copper wire and fiber optics, including the wires that comprise bus 702. Transmission media can also take the form of electromagnetic, acoustic, or light waves, such as those generated during radio-wave, infra-red, cellular, WiFi, or Bluetooth data communications.

Various forms of media may be involved in carrying one or more sequences of one or more instructions to processor 704 for execution. For example, the instructions may initially be carried on a magnetic disk or solid-state drive of a remote computer. The remote computer can load the instructions into its dynamic memory and send the instructions over a telephone line using a modem. A modem local to computer system 700 can receive the data on the telephone line and use an infra-red transmitter to convert the data to an infra-red signal. An infra-red detector can receive the data carried in the infra-red signal and appropriate circuitry can place the data on bus 702. Bus 702 carries the data to main memory 706, from which processor 704 retrieves and executes the instructions. The instructions received by main memory 706 may retrieves and executes the instructions. The instructions received by main memory 706 may optionally be stored on storage device 710 either before or after execution by processor 704.

The computer system 700 may also include a communication interface 718 coupled to bus 702. Communication interface 718 provides a two-way data communication coupling to one or more network links that are connected to one or more local networks. For example, communication interface 718 may be an integrated services digital network (ISDN) card, cable modem, satellite modem, or a modem to provide a data communication connection to a corresponding type of telephone line. As another example, communication interface 718 may be a local area network (LAN) card to provide a data communication connection to a compatible LAN (or WAN component to communicate with a WAN). Wireless links may also be implemented. In any such implementation, communication interface 718 sends and receives electrical, electromagnetic or optical signals that carry digital data streams representing various types of information.

A network link typically provides data communication through one or more networks to other data devices. For example, a network link may provide a connection through a local network to a host computer or to data equipment operated by an Internet Service Provider (ISP). The ISP in turn provides data communication services through the world wide packet data communication network now commonly referred to as the “Internet”. Local network and Internet both use electrical, electromagnetic or optical signals that carry digital data streams. The signals through the various networks and the signals on network link and through communication interface 718, which carry the digital data to and from computer system 700, are example forms of transmission media.

The computer system 700 can send messages and receive data, including program code, through the network(s), network link and communication interface 718. In the Internet example, a server might transmit a requested code for an application program through the Internet, the ISP, the local network and the communication interface 718.

The received code may be executed by processor 704 as it is received, and/or stored in storage device 710, or other non-volatile storage for later execution.

FIG. 8 illustrates a flowchart 800 of a method according to some embodiments. In this and other flowcharts, the flowchart 800 illustrates by way of example a sequence of steps. It should be understood the steps may be reorganized for parallel execution, or reordered, as applicable. Moreover, some steps that could have been included may have been removed to avoid providing too much information for the sake of clarity and some steps that were included could be removed, but may have been included for the sake of illustrative clarity.

In step 802, an image or video may be received. In step 804, the image or video may be parsed. In step 806, the image or video may be processed to compute low-level, midlevel, or high-level cues. In step 808, camera parameters and models of the scene and/or objects or entities in the scene may be generated. In step 810, additional objects or entities may be incorporated in the scene. In step 812, the additional objects and entities may be displayed in the image or video from step 802.

FIG. 9 illustrates an example environment 900, in accordance with various embodiments. The example environment 900 may include at least one computing system 902 that includes one or more processors and memory. The processors may be configured to perform various operations by interpreting machine-readable instructions. In some embodiments, the example environment 900 may be implemented as a data platform. In some embodiments, the example environment 900 may be configured to interact with computing systems of the data platform. In various embodiments, computing systems of the data platform may receive and process search queries to obtain sensor data describing an operation of a workflow and information describing the workflow.

In some embodiments, the computing system 902 may include a process engine 904. The process engine 904 may include a segmentation engine 906, a computer vision engine 908, a 3-D reconstruction engine 910, and recommendation engine 912. The process engine 904 may be executed by the processor(s) of the computing system 902 to perform various operations including those operations described in reference to the segmentation engine 906, the computer vision engine 908, 3-D reconstruction engine 910, and recommendation engine 912. In general, the process engine 904 may be implemented, in whole or in part, as software that is capable of running on one or more computing devices or systems. In one example, the process engine 904 may be implemented as or within a software application running on one or more computing devices (e.g., user or client devices) and/or one or more servers (e.g., network servers or cloud servers). In some instances, various aspects of the segmentation engine 906, the computer vision engine 908, 3-D reconstruction engine 910, and recommendation engine 912 may be implemented in one or more computing systems and/or devices. The environment 900 may also include one or more servers 930 accessible to the computing system 902. The one or more servers 930 may be accessible to the computing system 902 either directly or over a network 950. In some embodiments, the one or more servers 930 may store data that may be accessed by the process engine 904 to provide the various features described herein. In some instances, the one or more servers 930 may include federated data stores, databases, or any other type of data source from which data may be stored and retrieved, for example. In some implementations, the one or more servers 930 may include various types of data sets on which determinations of accuracy or consistency with other information can be made. In general, a user operating a computing device 920 or a mobile device 931 can interact with the computing system 902 over the network 950, for example, through one or more graphical user interfaces and/or application programming interfaces. For example, a user, through the computing device 920 or the mobile device 931, can request, view, and/or access details of the computing system 902, including data input into or generated from the segmentation engine 906, the computer vision engine 908, 3-D reconstruction engine 910, and recommendation engine 912.

The segmentation engine 906 may be configured to parse a 2D image or video of a scene, for example, after the 2D image or video has been input or uploaded by a user. The segmentation engine 906 may be configured to parse the photo into different image regions or portions. Each of the image regions or portions may be associated with or include different semantic categories, such as portions of a room, which may include an entrance, ground, walls, and ceiling. In some examples, the segmentation engine 906 may utilize a generative approach, a discriminative approach, and/or a Bayesian framework. In some examples, algorithms used by the segmentation engine 906 may produce a semantic segmentation mask predicting a semantic category for each pixel in the photo. The computer vision engine 908 may process the photo to determine low-level, mid-level, and/or high-level cues. The 3-D reconstruction engine 910 may integrate data from the segmentation engine 906 and the computer vision engine 908 to generate sensor parameters, such as camera parameters, and scene description. The recommendation engine 912 may suggest objects or entities or placement of objects based on historical data and/or user preference.

Each of the processes, methods, and algorithms described in the preceding sections may be embodied in, and fully or partially automated by, code modules executed by one or more computer systems or computer processors comprising computer hardware. The processes and algorithms may be implemented partially or wholly in application-specific circuitry.

Certain embodiments are described herein as including logic or a number of components, engines, or mechanisms. Engines may constitute either software engines (e.g., code embodied on a machine-readable medium) or hardware engines. A “hardware engine” is a tangible unit capable of performing certain operations and may be configured or arranged in a certain physical manner. In various example embodiments, one or more computer systems (e.g., a standalone computer system, a client computer system, or a server computer system) or one or more hardware engines of a computer system (e.g., a processor or a group of processors) may be configured by software (e.g., an application or application portion) as a hardware engine that operates to perform certain operations as described herein.

In some embodiments, a hardware engine may be implemented mechanically, electronically, or any suitable combination thereof. For example, a hardware engine may include dedicated circuitry or logic that is permanently configured to perform certain operations. For example, a hardware engine may be a special-purpose processor, such as a Field-Programmable Gate Array (FPGA) or an Application Specific Integrated Circuit (ASIC). A hardware engine may also include programmable logic or circuitry that is temporarily configured by software to perform certain operations. For example, a hardware engine may include software executed by a general-purpose processor or other programmable processor. Once configured by such software, hardware engines become specific machines (or specific components of a machine) uniquely tailored to perform the configured functions and are no longer general-purpose processors. It will be appreciated that the decision to implement a hardware engine mechanically, in dedicated and permanently configured circuitry, or in temporarily configured circuitry (e.g., configured by software) may be driven by cost and time considerations.

Accordingly, the phrase “hardware engine” should be understood to encompass a tangible entity, be that an entity that is physically constructed, permanently configured (e.g., hardwired), or temporarily configured (e.g., programmed) to operate in a certain manner or to perform certain operations described herein. As used herein, “hardware-implemented engine” refers to a hardware engine. Considering embodiments in which hardware engines are temporarily configured (e.g., programmed), each of the hardware engines need not be configured or instantiated at any one instance in time. For example, where a hardware engine comprises a general-purpose processor configured by software to become a special-purpose processor, the general-purpose processor may be configured as respectively different specialpurpose processors (e.g., comprising different hardware engines) at different times. Software accordingly configures a particular processor or processors, for example, to constitute a particular hardware engine at one instance of time and to constitute a different hardware engine at a different instance of time.

Hardware engines can provide information to, and receive information from, other hardware engines. Accordingly, the described hardware engines may be regarded as being communicatively coupled. Where multiple hardware engines exist contemporaneously, communications may be achieved through signal transmission (e.g., over appropriate circuits and buses) between or among two or more of the hardware engines. In embodiments in which multiple hardware engines are configured or instantiated at different times, communications between such hardware engines may be achieved, for example, through the storage and retrieval of information in memory structures to which the multiple hardware engines have access. For example, one hardware engine may perform an operation and store the output of that operation in a memory device to which it is communicatively coupled. A further hardware engine may then, at a later time, access the memory device to retrieve and process the stored output. Hardware engines may also initiate communications with input or output devices, and can operate on a resource (e.g., a collection of information).

The various operations of example methods described herein may be performed, at least partially, by one or more processors that are temporarily configured (e.g., by software) or permanently configured to perform the relevant operations. Whether temporarily or permanently configured, such processors may constitute processor-implemented engines that operate to perform one or more operations or functions described herein. As used herein, “processor-implemented engine” refers to a hardware engine implemented using one or more processors.

Similarly, the methods described herein may be at least partially processor-implemented, with a particular processor or processors being an example of hardware. For example, at least some of the operations of a method may be performed by one or more processors or processor-implemented engines. Moreover, the one or more processors may also operate to support performance of the relevant operations in a “cloud computing” environment or as a “software as a service” (SaaS). For example, at least some of the operations may be performed by a group of computers (as examples of machines including processors), with these operations being accessible via a network (e.g., the Internet) and via one or more appropriate interfaces (e.g., an Application Program Interface (API)).

The performance of certain of the operations may be distributed among the processors, not only residing within a single machine, but deployed across a number of machines. In some example embodiments, the processors or processor-implemented engines may be located in a single geographic location (e.g., within a home environment, an office environment, or a server farm). In other example embodiments, the processors or processor-implemented engines may be distributed across a number of geographic locations.

Language

Throughout this specification, plural instances may implement components, operations, or structures described as a single instance. Although individual operations of one or more methods are illustrated and described as separate operations, one or more of the individual operations may be performed concurrently, and nothing requires that the operations be performed in the order illustrated. Structures and functionality presented as separate components in example configurations may be implemented as a combined structure or component. Similarly, structures and functionality presented as a single component may be implemented as separate components. These and other variations, modifications, additions, and improvements fall within the scope of the subject matter herein.

Although an overview of the subject matter has been described with reference to specific example embodiments, various modifications and changes may be made to these embodiments without departing from the broader scope of embodiments of the present disclosure. Such embodiments of the subject matter may be referred to herein, individually or collectively, by the term “invention” merely for convenience and without intending to voluntarily limit the scope of this application to any single disclosure or concept if more than one is, in fact, disclosed.

The embodiments illustrated herein are described in sufficient detail to enable those skilled in the art to practice the teachings disclosed. Other embodiments may be used and derived therefrom, such that structural and logical substitutions and changes may be made without departing from the scope of this disclosure. The Detailed Description, therefore, is not to be taken in a limiting sense, and the scope of various embodiments is defined only by the claims, along with the full range of equivalents to which such claims are entitled.

It will be appreciated that an “engine,” “system,” “data store,” and/or “database” may comprise software, hardware, firmware, and/or circuitry. In one example, one or more software programs comprising instructions capable of being executable by a processor may perform one or more of the functions of the engines, data stores, databases, or systems described herein. In another example, circuitry may perform the same or similar functions. Alternative embodiments may comprise more, less, or functionally equivalent engines, systems, data stores, or databases, and still be within the scope of present embodiments. For example, the functionality of the various systems, engines, data stores, and/or databases may be combined or divided differently.

The data stores described herein may be any suitable structure (e.g., an active database, a relational database, a self-referential database, a table, a matrix, an array, a flat file, a documented-oriented storage system, a non-relational No-SQL system, and the like), and may be cloud-based or otherwise.

The various features and processes described above may be used independently of one another, or may be combined in various ways. All possible combinations and subcombinations are intended to fall within the scope of this disclosure. In addition, certain method or process blocks may be omitted in some implementations. The methods and processes described herein are also not limited to any particular sequence, and the blocks or states relating thereto can be performed in other sequences that are appropriate. For example, described blocks or states may be performed in an order other than that specifically disclosed, or multiple blocks or states may be combined in a single block or state. The example blocks or states may be performed in serial, in parallel, or in some other manner. Blocks or states may be added to or removed from the disclosed example embodiments. The example systems and components described herein may be configured differently than described. For example, elements may be added to, removed from, or rearranged compared to the disclosed example embodiments.

Any process descriptions, elements, or blocks in the flow diagrams described herein and/or depicted in the attached figures should be understood as potentially representing modules, segments, or portions of code which may include one or more executable instructions for implementing specific logical functions or steps in the process. Alternate implementations are included within the scope of the embodiments described herein in which elements or functions may be deleted, executed out of order from that shown or discussed, including substantially concurrently or in reverse order, depending on the functionality involved, as would be understood by those skilled in the art.

It should be emphasized that many variations and modifications may be made to the above-described embodiments, the elements of which are to be understood as being among other acceptable examples. All such modifications and variations are intended to be included herein within the scope of this disclosure. The foregoing description details certain embodiments of the invention. It will be appreciated, however, that no matter how detailed the foregoing appears in text, the invention can be practiced in many ways. As is also stated above, it should be noted that the use of particular terminology when describing certain features or aspects of the invention should not be taken to imply that the terminology is being re-defined herein to be restricted to including any specific characteristics of the features or aspects of the invention with which that terminology is associated. The scope of the invention should therefore be construed in accordance with the claims and any equivalents thereof.

As used herein, the term “or” may be construed in either an inclusive or exclusive sense. Moreover, plural instances may be provided for resources, operations, or structures described herein as a single instance. Additionally, boundaries between various resources, operations, engines, engines, and data stores are somewhat arbitrary, and particular operations are illustrated in a context of specific illustrative configurations. Other allocations of functionality are envisioned and may fall within a scope of various embodiments of the present disclosure. In general, structures and functionality presented as separate resources in the example configurations may be implemented as a combined structure or resource. Similarly, structures and functionality presented as a single resource may be implemented as separate resources. These and other variations, modifications, additions, and improvements fall within a scope of embodiments of the present disclosure as represented by the claims. The specification and drawings are, accordingly, to be regarded in an illustrative rather than a restrictive sense.

Conditional language, such as, among others, “can,” “could,” “might,” or “may,” unless specifically stated otherwise, or otherwise understood within the context as used, is generally intended to convey that certain embodiments include, while other embodiments do not include, certain features, elements and/or steps. Thus, such conditional language is not generally intended to imply that features, elements and/or steps are in any way required for one or more embodiments or that one or more embodiments necessarily include logic for deciding, with or without user input or prompting, whether these features, elements and/or steps are included or are to be performed in any particular embodiment.

For example, “is to be” could mean, “should be,” “needs to be,” “is required to be,” or “is desired to be,” in some embodiments.

In the following description, certain specific details are set forth in order to provide a thorough understanding of various embodiments of the invention. However, one skilled in the art will understand that the invention may be practiced without these details. Moreover, while various embodiments of the invention are disclosed herein, many adaptations and modifications may be made within the scope of the invention in accordance with the common general knowledge of those skilled in this art. Such modifications include the substitution of known equivalents for any aspect of the invention in order to achieve the same result in substantially the same way.

Unless the context requires otherwise, throughout the present specification and claims, the word “comprise” and variations thereof, such as, “comprises” and “comprising” are to be construed in an open, inclusive sense, that is as “including, but not limited to.” Recitation of numeric ranges of values throughout the specification is intended to serve as a shorthand notation of referring individually to each separate value falling within the range inclusive of the values defining the range, and each separate value is incorporated in the specification as it were individually recited herein. Additionally, the singular forms “a,” “an,” and “the” include plural referents unless the context clearly dictates otherwise. The phrases “at least one of,” “at least one selected from the group of,” or “at least one selected from the group consisting of,” and the like are to be interpreted in the disjunctive (e.g., not to be interpreted as at least one of A and at least one of B).

Reference throughout this specification to “one embodiment” or “an embodiment” means that a particular feature, structure or characteristic described in connection with the embodiment is included in at least one embodiment of the present invention. Thus, the appearances of the phrases “in one embodiment” or “in an embodiment” in various places throughout this specification are not necessarily all referring to the same embodiment, but may be in some instances. Furthermore, the particular features, structures, or characteristics may be combined in any suitable manner in one or more embodiments.

Although the invention(s) have been described in detail for the purpose of illustration based on what is currently considered to be the most practical and preferred implementations, it is to be understood that such detail is solely for that purpose and that the invention is not limited to the disclosed implementations, but, on the contrary, is intended to cover modifications and equivalent arrangements that are within the spirit and scope of the claims. For example, it is to be understood that the present invention contemplates that, to the extent possible, one or more features of any embodiment can be combined with one or more features of any other embodiment.

The foregoing description of the present invention(s) have been provided for the purposes of illustration and description. It is not intended to be exhaustive or to limit the invention to the precise forms disclosed. The breadth and scope of the present invention should not be limited by any of the above-described exemplary embodiments. Many modifications and variations will be apparent to the practitioner skilled in the art. The modifications and variations include any relevant combination of the disclosed features. The embodiments were chosen and described in order to best explain the principles of the invention and its practical application, thereby enabling others skilled in the art to understand the invention for various embodiments and with various modifications that are suited to the particular use contemplated. It is intended that the scope of the invention be defined by the claims and their equivalence.

What is claimed is:

1. A method for incorporating an object in a scene comprising:
receiving an image of a scene;
generating a three-dimensional model of the scene, wherein the model of the scene comprises geometric and semantic information of the scene;
determining placement of an object in the scene by analyzing the geometric and semantic information of the object;
rendering a visual representation of the object in the scene.

2. The method of claim 1, wherein the image is a two-dimensional image.

3. The method of claim 1, wherein the scene comprises a room of a house, condominium, or apartment.

4. The method of claim 1, wherein the model of the scene comprises semantic information of a wall, floor, ceiling, window, door, or wall opening.

5. The method of claim 1, wherein the geometric information comprises length, width, height, or other dimension.

6. The method of claim 1, wherein the geometric information comprises scale, rotation, translation, or other transformation.

7. The method of claim 1, wherein the geometric information comprises curvature, surface normal, plane, or other geometry describing the surface.

8. The method of claim 1, wherein the geometric information comprises a cuboid, spheroid, cylinder, torus, cone or other three-dimensional shape.

9. The method of claim 1, wherein the semantic information comprises name, category, or affordances of the object or element of the scene.

10. The method of claim 1, wherein the semantic information comprises a relationship to another object or element of the scene.

11. The method of claim 10, wherein the semantic information comprises a parent or child relationship to another object or element of the scene.

12. The method of claim 10, wherein the semantic information comprises a maximum distance or minimum distance between the object and another object or element of the scene.

13. The method of claim 1, wherein generating a visual representation of the object in the scene comprises incorporating a visual representation of the object in the image of the scene.

14. The method of claim 1, wherein generating a visual representation of the object in the scene comprises generating a two-dimensional image of the object and scene.

15. The method of claim 1, wherein generating a visual representation of the object in the scene comprises representing the object as occluded by or occluding an object or element of the scene based on camera parameters and the semantic information.

16. The method of claim 1, further comprising:
determining a constraint for the object based on geometric and semantic information of the object and scene;
in response to a user input, changing the placement of the object, subject to the constraint.

17. The method of claim 16, wherein the constraint restricts the movement of the object along the surface of another object or element in the scene.

18. The method of claim 17, wherein the constraint restricts the movement of the back of the object along the plane of a wall.

19. The method of claim 17, wherein the constraint restricts the movement of the bottom of the object along the plane of the floor.

20. The method of claim 17, wherein the constraint restricts the movement of the top of the object along the plane of the ceiling.

21. The method of claim 1, further comprising storing geometric and semantic information of the object as state information associated with the object.

22. The method of claim 21, wherein the state information is embedded in the image file.
